(19) United States
(12) Patent Application Publication
(10) Pub. No.: US 2024/0416545 A1
(43) Pub. Date: Dec. 19, 2024

(54) CHAINSAW

(71) Applicant: Greenworks (Jiangsu) Co., Ltd., Changzhou (CN)

(72) Inventors: Shu Huang, Changzhou (CN); Lingao Zhang, Changzhou (CN)

(21) Appl. No.: 18/822,458

(22) Filed: Sep. 2, 2024

Related U.S. Application Data
(63) Continuation of application No. PCT/CN2023/079549, filed on Mar. 3, 2023.

(30) Foreign Application Priority Data
Mar. 4, 2022 (CN) 202220462057.3
Jun. 23, 2022 (CN) 202221587287.9
Jun. 29, 2022 (CN) 202221668111.6

(51) Int. Cl. B27B 17/14; B27B 17/02; H02K 5/20; H02K 7/14

(52) U.S. Cl. CPC B27B 17/14; B27B 17/02; H02K 5/207; H02K 7/145

(57) ABSTRACT

A chainsaw includes a housing, a cutter, a motor, a tensioning assembly and an air guiding cover. The housing is provided with at least one air inlet and one air outlet. The cutter mounted on the housing includes a saw chain and a guiding bar to support the saw chain. The motor is arranged in the housing and used to drive the cutter to work. The tensioning assembly is mounted on the housing and connected with the guiding bar to adjust a tightness of the saw chain. The air guiding cover is arranged in the housing, and the motor is arranged in the air guiding cover. The housing includes a mounting groove for mounting the tensioning assembly. Heat dissipation passages are arranged between the air inlet, air guiding cover, and the air outlet to dissipate hot airflow generated by the motor to an outside.

### CROSS REFERENCE TO RELATED APPLICATION

The present application is a continuation Application of PCT application No. PCT/CN2023/079549 filed on Mar. 3, 2023, which claims the benefit of CN202221587287.9 filed on Jun. 23, 2022, CN202220462057.3 filed on Mar. 4, 2022 and CN202221668111.6 filed on Jun. 29, 2022. All the above are hereby incorporated by reference for all purposes.

### TECHNICAL FIELD

The disclosure belongs to a technical field of garden tools, and specifically relates to a chainsaw.

### BACKGROUND

Chainsaw is a kind of handsaw powered by gasoline, electricity or hydraulics, which is usually used to cut wood, stone, steel, etc., which effectively saves time, manpower, etc. spent on cutting materials, thereby improving user's work efficiency. A chainsaw typically includes a saw blade assembly, a motor that drives the saw blade assembly to work, and a housing. The housing includes a main casing accommodating the motor and a motor cover covering a tail of the motor.

During a use of the chainsaw, there will be problems such as loose chain links, untimely heat dissipation, high motor temperature, and easy damage to the motor.

### SUMMARY

The disclosure provides a chainsaw, that not only solves a problem of low connection stability between a tensioning device and a housing of the chainsaw, but also solves a problem of turbulence in airflow at an air outlet of the motor, thereby reducing air discharging efficiency of the motor. At the same time, it improves a problem that a heat dissipation structure of the chainsaw cannot be dustproof and waterproof at the same time during use.

The disclosure provides the chainsaw. The chainsaw includes a housing, a cutter, a motor, a tensioning assembly and an air guiding cover. The housing is provided with at least one air inlet and one air outlet. The cutter is mounted on the housing and includes a saw chain and a guiding bar to support the saw chain. The motor is arranged in the housing and used to drive the cutter to work. The tensioning assembly is mounted on the housing and connected with the guiding bar to adjust a tightness of the saw chain. The air guiding cover is arranged in the housing, and the motor is arranged in the air guiding cover. Wherein, the housing is provided with a mounting groove for mounting the tensioning assembly. Heat dissipation passages are arranged between the air inlet, the air guiding cover and the air outlet to dissipate hot airflow generated by the motor to an outside.

In an embodiment of the disclosure, an embedded hole is arranged in a side wall of the mounting groove, a first end of the tensioning assembly is fixedly connected with a bottom wall of the mounting groove, and a second end of the tensioning assembly stretches into the embedded hole and is rotatable in the embedded hole.

In an embodiment of the disclosure, a protective part is arranged at a bottom of the air inlet, and the protective part is provided with a strip-shaped protruding ribs located at an edge of the heat dissipation passage.

In an embodiment of the disclosure, the protective part includes a protective plate and a connecting plate, and the protective plate and the connecting plate are arranged at an angle.

In an embodiment of the disclosure, the connecting plate is arranged opposite to the heat dissipation passage, one end of the connecting plate away from the protective plate is fixedly connected with a top of the housing, an edge of the protective plate away from the connecting plate is provided with the protruding rib, and the protruding rib is arranged along an edge of the protective plate and is higher than the protective plate.

In an embodiment of the disclosure, the air guiding opening is arranged corresponding to a position and a size of the air outlet.

In an embodiment of the disclosure, an area of the air guiding opening is equal to an arca of the air outlet.

In an embodiment of the disclosure, the tensioning assembly includes a fixing part, an adjusting part and a transmitting component, the fixing part is fixedly connected with the bottom wall of the mounting groove through a pin, a plurality of grooves and through holes matched with the transmitting component are opened therein, the adjusting part is slidably connected with the fixing part through the transmitting component, the transmitting component is in a transmission connection with the adjusting part, and one end of the transmitting component extends into the embedded hole.

In an embodiment of the disclosure, the fixing part includes a first fixing part and a second fixing part that is vertically fixedly connected with the first fixing part, the transmitting component includes a driving helical gear rotatably connected with the first fixing part, a driven helical gear rotatably connected with the second fixing part, located below the driving helical gear, and meshed with the driving helical gear, and a transmission rod, a first end of the transmission rod is coaxially fixed with the driven helical gear, and is in a transmission connection with the adjusting part, and a second end of the transmission rod extends into the embedded hole.

In an embodiment of the disclosure, the mounting groove includes a first mounting groove and a second mounting groove, the first fixing part and the driving helical gear are arranged in the first mounting groove, the second fixing part, the adjusting part, the driven helical gear and the transmission rod are arranged in the second mounting groove, the second fixing part is fixedly connected with a bottom wall of the second mounting groove through a pin, and the embedded hole is opened in a side wall of the second mounting groove close to the saw chain.

In an embodiment of the disclosure, the air guiding cover includes a first cover and a second cover, the second cover is connected with the first cover, a cavity is arranged between the first cover and the second cover, an air guiding tube is further connected with one side of the first cover away from the second cover, the air guiding tube is connected with the motor, a bottom of the second cover is provided with the air guiding opening, and the air guiding opening is communicated with the cavity.

In an embodiment of the disclosure, the air guiding opening is arranged opposite to the air outlet, and the heat dissipation passages are formed between the air inlet, the cavity, the air guiding opening and the air outlet.

In an embodiment of the disclosure, a blower chamber is further formed between the first cover and the second cover, and a blower is arranged in the blower chamber.

In an embodiment of the disclosure, the housing includes a first casing, a second casing and an upper cover, the second casing is connected with the first casing and forms an empty cavity between the first casing, the motor is arranged in the empty cavity, and the upper cover is fixed on tops of the first casing and the second casing.

In an embodiment of the disclosure, a plurality of the air outlets is arranged at a bottom of the first casing and arranged lincarly.

Beneficial effects of the disclosure are that: the motor and the blower are arranged in the air guiding cover, which prevents the hot airflow around the motor from flowing inside the housing, at the same time, heat dissipation passages are formed between the air inlet, the cavity, the air guiding opening and the air outlet to speed up heat dissipation efficiency of the chainsaw, the air guiding opening is closely connected with the air outlet to strengthen an exchange of cold and hot airflow, furthermore, the area of the air guiding opening and the area of the air outlet are set in a same way to improve blowing efficiency and increase a heat dissipation effect accordingly.

In addition, the fixing part is fixed with the bottom wall of the mounting groove through the pin, so that a connection stability of the tensioning assembly on the housing may be increased. An end of the transmission rod away from the fixing part extends into the embedded hole of the mounting groove, so that a quick fixation of the tensioning assembly may be realized, and the connection stability between the tensioning assembly and the housing is improved.

The disclosure further arranges the protective part at the bottom of the air inlet, and the protruding ribs are formed at the edge of the protective plate, which can effectively block moisture and dust while ensuring the heat dissipation, and prevents the dust and moisture carried in the airflow from directly entering an inside of the housing from the air inlet and damaging the motor.

### BRIEF DESCRIPTION OF THE DRAWINGS

FIG. 1 is an axial side view of a chainsaw according to at least one embodiment of the disclosure.

FIG. 2 is a second axial side view of the chainsaw according to at least one embodiment of the disclosure.

FIG. 3 is a schematic exploded view of the chainsaw according to at least one embodiment of the disclosure.

FIG. 4 is an axial side view of a second casing of the chainsaw according to at least one embodiment of the disclosure.

FIG. 5 is a side view of a first casing of the chainsaw according to at least one embodiment of the disclosure.

FIG. 6 is a schematic internal structural view of the chainsaw according to at least one embodiment of the disclosure.

FIG. 7 is a top view of the second casing of the chainsaw according to at least one embodiment of the disclosure.

FIG. 8 is a top view of the chainsaw according to at least one embodiment of the disclosure.

FIG. 9 is a partial schematic structural view of a side view of the chainsaw according to at least one embodiment of the disclosure.

FIG. 10 is a schematic structural view of an air inlet of the chainsaw according to at least one embodiment of the disclosure.

FIG. 11 is a schematic structural view of a cross-section of a protective part of the chainsaw according to at least one embodiment of the disclosure.

FIG. 12 is a schematic mounting view of a tensioning assembly of the chainsaw according to at least one embodiment of the disclosure.

FIG. 13 is a partial exploded view of FIG. 12.

FIG. 14 is a schematic structural view of a mounting groove of the chainsaw according to at least one embodiment of the disclosure.

FIG. 15 is an axial side view of the tensioning assembly of the chainsaw according to at least one embodiment of the disclosure.

FIG. 16 is a schematic structural view of a transmitting component of the chainsaw according to at least one embodiment of the disclosure.

FIG. 17 is a side view of a fixing part and an adjusting part of the chainsaw according to at least one embodiment of the disclosure.

### PART NUMBER DESCRIPTION

1—housing, 11—first handle, 12—second handle, 13—upper cover, 131—opening, 14—power supply socket, 15—first casing, 151—air inlet, 152—air outlet, 16—second casing, 161—mounting groove, 1611—first mounting groove, 1612—second mounting groove, 16121—embedded hole, 16122—first blocking wall, 16123—second blocking wall, 2—cutter, 21—saw chain, 22—guiding bar, 3—control assembly, 4—tensioning assembly, 41—fixing part, 411—first fixing part, 412—second fixing part, 42—adjusting part, 421—blocking edge, 43—transmitting component, 431—driving helical gear, 432—driven helical gear, 433—transmission rod, 434—first connecting shaft, 435—second connecting shaft, 436—pin, 5—motor, 6—air guiding cover, 61—first cover, 611—air guiding tube, 62—second cover, 63—air guiding opening, 64—cavity, 7—blower, 8—protective part, 81—connecting plate, 82—protective plate, 83—protruding rib.

### DETAILED DESCRIPTION

The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure. It should be noted that, the following embodiments and the features in the embodiments can be combined with each other without conflict.

It should be noted that drawings provided in the embodiments are only illustrative of a basic idea of the disclosure. The drawings only show assemblies related to the disclosure instead of drawing according to the number, shape and size of the assemblies in actual implementation. In actual implementation, the type, quantity and ratio of each assembly may be changed at will, and a layout of the assemblies may also be more complicated.

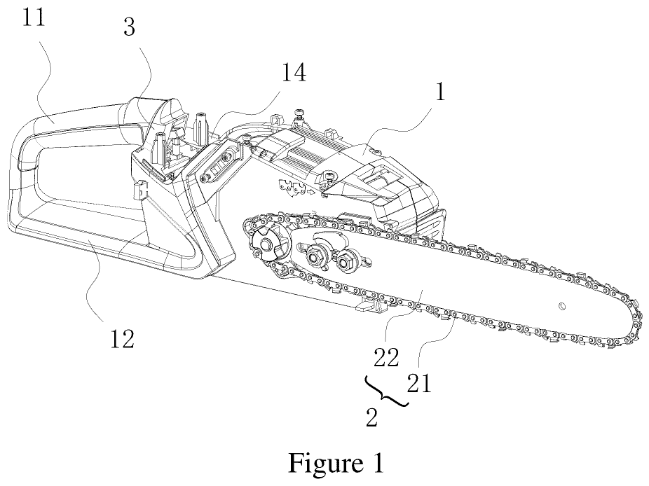

Please refer to FIG. 1 through FIG. 3. The disclosure provides a chainsaw. The chainsaw includes a housing 1, a cutter 2, a power assembly (not marked in the figure), a control assembly 3, a tensioning assembly 4 and a heat dissipation mechanism. The cutter 2 is mounted on the housing 1. The power assembly is housed in the housing 1 and is used to drive the cutter 2 to cut. The control assembly 3 is mounted on an end of the housing 1 away from the cutter 2 and is used to control the power assembly. The tensioning assembly 4 is arranged in the housing 1 and is in a transmission connection with a guiding bar 22 of the cutter 2. In an embodiment, the guiding bar 22 is driven to move through an adjustment of the tensioning assembly 4, so that a tension force of a saw chain 21 arranged on the guiding bar 22 circumferentially is adjusted. The heat dissipation mechanism is mounted on the power assembly in the housing 1 and is used to dissipate heat from the power assembly.

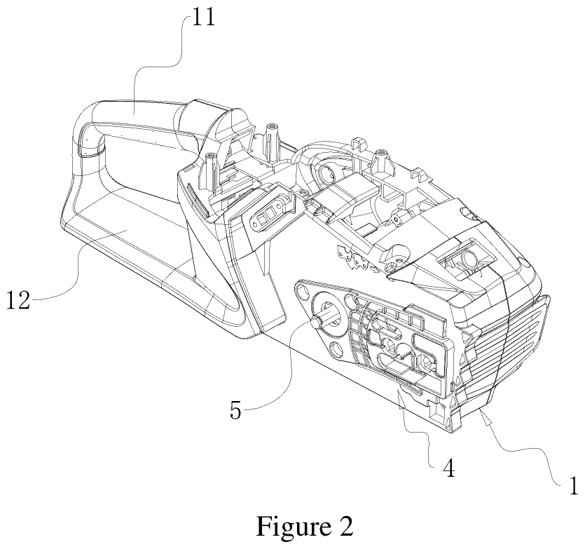

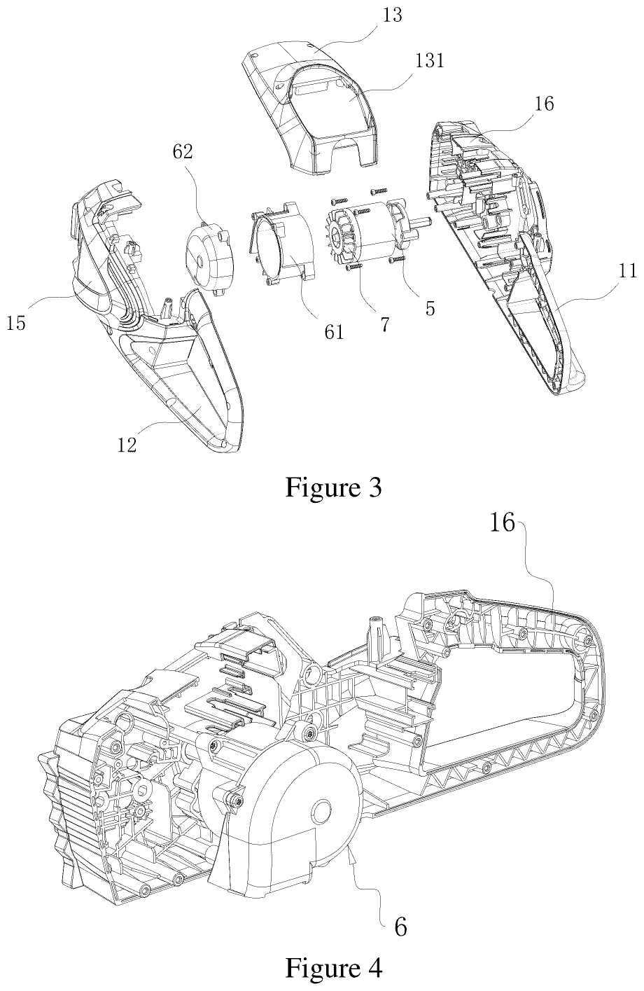

Please refer to FIG. 2 and FIG. 3. In this embodiment, the housing 1 is roughly in a shape of a long box, and the housing 1 includes a first casing 15, a second casing 16 and an upper cover 13. The first casing 15 and the second casing 16 are similar in shape and structure, and the first casing 15 and the second casing 16 are enclosed together to form an empty cavity (not indicated in the figure), and the empty cavity is used for mounting parts of the chainsaw, such as a motor 5, etc. An outer side wall of the second casing 16 is in a stepped shape, so that the cutter 2 may be mounted on an outer side of the casing 1, and is convenient for mounting and disassembly. The upper cover 13 is fixed on an upper side of the first casing 11 and the second casing 16, an opening 131 is further arranged on the upper cover 13, and the opening 131 corresponds to a power supply socket 14 on the housing 1, so that the battery pack is convenient to be inserted into the power supply socket 14 in the housing 1.

In this embodiment, a first handle 11 is arranged at a rear end of the housing 1, a second handle 12 is formed on a lower side of the housing 1, and a length direction of the first handle 11 is roughly parallel to an extending direction of a chainsaw assembly. The first handle 11 is formed by being surrounded by ends of the first casing 15 and the second casing 16, which means that the first handle 11 is integrally formed with the housing 1, so that on one hand, a connection stability between the first handle 11 and the housing 1 is enhanced, and a user is convenient for holding the chainsaw to carry out a cutting operation. On the other hand, production steps and processes of the housing 1 are simplified, and production cost of the chainsaw is reduced.

In addition, the control assembly 3 is mounted at the first handle 15, wherein the control assembly 3 includes a control board (not marked in the figure) and a switch trigger (not marked in the figure). The control board is arranged inside the housing 1 and is used for receiving an instruction transmitted by the switch trigger and controlling an on-off of the power assembly. The switch trigger is arranged at the first handle 15 and is electrically connected with the control board. A first end of the switch trigger penetrates in the housing 1 and is rotatably connected with an inner side wall of the housing 1, and a second end of the switch trigger extends to an outside of housing 1 and may facilitate the user's finger to toggle the switch trigger. In another embodiment of the disclosure, the first handle 11 may further be separated from the housing 1. It only needs to satisfy the connection stability between the first handle 11 and the housing 1 and ensure a feasibility of the user holding the chainsaw.

Please refer to FIG. 1. In this embodiment, the cutter 2 includes the saw chain 21 and the guiding bar 22 for supporting the saw chain 21. One end of the guiding bar 22 is arranged inside the housing 1 through a fastener, and another part of the guiding bar 22 extends forward along a length direction of the housing 1. The saw chain 21 is arranged around a side wall of the guiding bar 22, and the saw chain 21 is rotatably connected with the guiding bar 22 and may rotate at a high speed under a driving of the power assembly to perform cutting operation.

Please refer to FIG. 2. In this embodiment, the power assembly includes a driving unit for driving the cutter 2 and a power supply unit for supplying power for the driving unit. It should be noted that, the driving unit is the motor 5 in this embodiment, and one end of an output shaft of the motor 5 passes through the second casing 16 and extends to an outside of the housing 1, so that the cutter 2 and the motor 5 are convenient to be mounted or disassembled. In addition, in other embodiments of the disclosure, the driving unit may also be a power machine such as an enginc. The power supply unit includes the power supply socket 14 and a battery pack (not marked in the figure) that is detachably connected with the power supply socket 14. Further, the power supply socket 14 is arranged between the second handle 12 and the first handle 11, so that a center of gravity of the chainsaw may be located at a center position of the first handle 11 perpendicular to the housing 1, and a width of two sides of the power supply socket 14 is within a range of twice a width of the housing 1. This arrangement may effectively ensure a stability of the chainsaw when placed.

In an embodiment of the disclosure, there are two power supply sockets 14 symmetrically arranged, and they are located on two sides of a width direction of the housing 1, so that the battery pack may be plugged and fixed on the outside of the housing 1. This arrangement may facilitate a replacement and a charging of the battery pack, and further improve a practicality of the chainsaw.

Specifically, the power supply unit further includes a connector (not marked in the figure) arranged on the housing 1 for connecting the battery pack, and the power supply socket 14 is arranged correspondingly to the connector so that the battery pack is detachably connected with the housing 1 through the connector and is electrically connected with the power supply socket 14. In this embodiment, the connector includes a power supply accommodating cavity and a guiding rail groove arranged in the power supply accommodating cavity, and the connector is symmetrically arranged on the two sides of the housing 1. The power supply socket 14 is housed in the power supply accommodating cavity, and the battery pack is clamped and housed in the power supply accommodating cavity through the guiding rail groove, so that an electrical connection between the battery pack and the power supply socket 14 is stable, which effectively prevents a power supply abnormality of the chainsaw caused by a detachment between the battery pack and the power supply accommodating cavity.

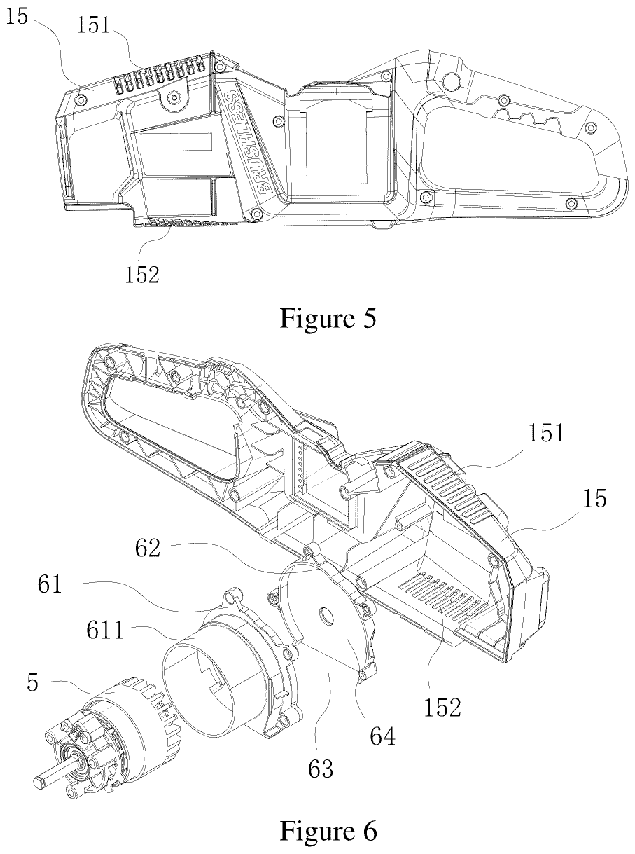

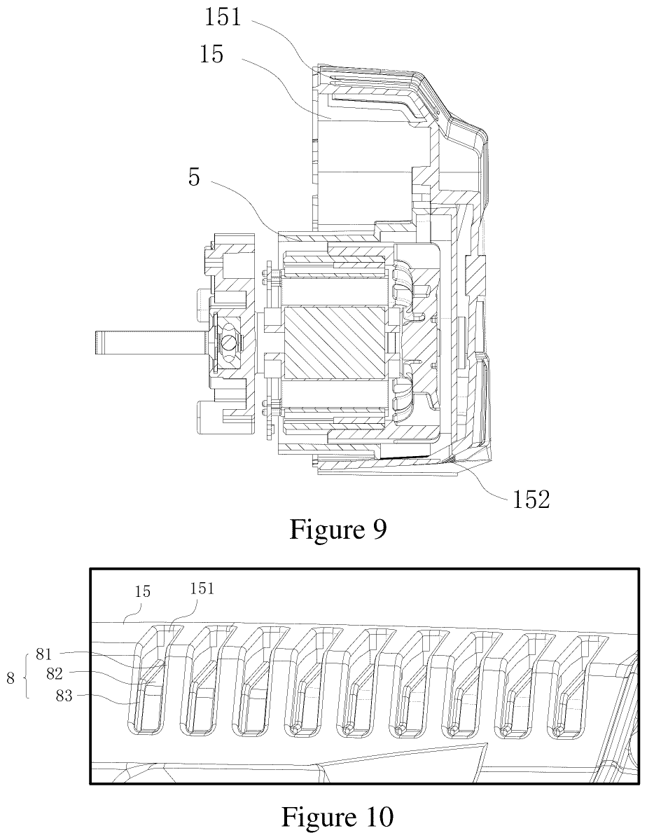

Please refer to FIG. 5, FIG. 6 and FIG. 9. In a specific embodiment, at least one air inlet 151 and one air outlet 152 may be allowed to be arranged on the housing 1 of the chainsaw, and airflow may be allowed to enter an inside of the chainsaw through the air inlet 151, and be discharged from the chainsaw through the air outlet 152. Therefore, during a working process of the chainsaw, the airflow outside the chainsaw may be allowed to enter the inside of the chainsaw and take away heat generated by the chainsaw during the working process, so as to cool the chainsaw. It should be noted that, a protective part 8 is arranged at a bottom of the air inlet 151, and the protective part 8 may be used to protect the inside of the housing 1 to avoid impurities and a small amount of liquid from entering the housing 1 through the air inlet 151.

In an embodiment, the air inlet 151 and the air outlet 152 are located on the first casing 15, and there are pluralities of groups of the air inlets 151 and the air outlets 152 respectively. Wherein, the plurality of groups of the air inlets 151 is arranged at a top of the first casing 15 and is linearly arranged, and the plurality of groups of the air outlets 152 is arranged at a bottom of the first casing 15 and are linearly arranged.

Please refer to FIG. 3 and FIG. 4. In this embodiment, the housing 1 is further connected with an air guiding cover 6, and the air guiding cover 6 is connected with the motor 5. The air guiding cover 6 is used for mounting the motor 5 of power assembly and a blower 7 in the heat dissipation mechanism, forms heat dissipation passages with the air inlet 151 and the air outlet 152, and improves a heat dissipation effect inside the chainsaw through the heat dissipation passages. In an embodiment, the air guiding cover 6 includes a first cover 61 and a second cover 62, and the first cover 61 may be detachably connected with the second cover 62 for a quick mounting. However, it is not limited to this. A specific connection method between the first cover 61 and the second cover 62 may be determined according to actual needs. For example, the first cover 61 and the second cover 62 may also be integrally formed.

In this embodiment, it is explained that the first cover 61 and the second cover 62 are detachably connected. The first cover 61 is a hollow cylinder. The first cover 61 is sleeved on an outside of the motor 5 and is fixedly connected with the first casing 15 through bolts. A length of the motor 5 is greater than a length of the first cover 61, and cooling airflow can enter the first cover 61 from a gap between the first cover 61 and the first casing 15. A structure of the second cover 62 is volute-shaped, and the second cover 62 is fixed with the first cover 61 through the bolts.

In an embodiment, please refer to FIG. 6. A plurality of threaded holes is opened on the first cover 61, a plurality of mounting holes is opened on the second cover 62, and the threaded holes correspond to the mounting holes. The bolts may be provided, and the bolts shall be threaded into the threaded holes after passing through the mounting holes. Through connecting the bolt and the threaded hole, the first cover 61 and the second cover 62 are connected with each other, so that a detachable connection is realized. At the same time, a blower chamber (not indicated in the figure) is formed between the second cover 62 and a bottom wall of the motor 5, and the blower chamber is used for accommodating the blower 7. Further, a cavity 64 is formed between the first cover 61 and the second cover 62, and the airflow is allowed to flow in the cavity 64. Therefore, when the airflow is flowing in the cavity 64, the flowing airflow may carry away the heat in the cavity 64.

Further, please refer to FIG. 6. An air guiding opening 63 is opened on the air deflector 6, and the air guiding opening 63 is formed by splicing the first cover 61 and the second cover 62. The air outlet 152 is arranged at the bottom of the first casing 15, and the air guiding opening 63 is aligned with the air outlet 152. It should be noted that a side wall of the air guiding opening 63 is attached to an inner wall of the first casing 15 located at the air outlet 152, thereby forming an air passage communicated with the outside. The flowing airflow may be discharged through the air guiding opening 63 and the air outlet 152. It should be noted that, a side of the first cover 61 away from the second cover 62 is further connected with an air guiding tube 611, a first end of the air guiding tube 611 is connected with the motor 5, and a second end of the air guiding tube 611 is communicated with the cavity 64. Therefore, the heat generated by the motor 5 in the working process enters the cavity 64 through the air guiding tube 611, and flowing air enters the cavity 64 through the air guiding tube 611, is discharged by the air guiding opening 63 on the air guiding cover 6, and then takes away the heat generated by the motor 5. When the motor 5 rotates, the blower 7 is driven to rotate. The blower 7 discharges air in the second cover 62 through the air guiding opening 63. A negative pressure is formed in the second cover 62, and guides air in the first cover 61 to the second cover 62, thereby forming the airflow. The cooling airflow for cooling the motor 5 is discharged from the first cover 61, the second housing 62 and the air outlet 151, and does not exchange heat with the air in the housing 1, which guarantees cooling efficiency.

In addition, connecting the air guiding opening 63 with the air outlet 152 closely may further prevent the hot airflow from flowing to other positions in the housing 1 when the hot and cold airflow in the blower chamber is exchanged, thereby reducing the heat dissipation effect. Therefore, after the airflow enters the chainsaw through the air inlet 151 and passes through the cavity 64 and the air guiding opening 63 in turn, the airflow is discharged from the chainsaw by the air outlet 152, and then the heat generated by the chainsaw in the working process is taken away. Wherein, a specific shape of the air inlet 151 may be determined according to actual needs. For example, the air inlet 151 may also be a rectangle, a circle, a polygonal and other shapes. In an embodiment of the disclosure, the second cover 62 is independently arranged with the first casing 15, thus ensuring a versatility of this heat dissipation method. Of course, the second cover 62 may also be fixedly connected with the casing 15 or integrally formed with it.

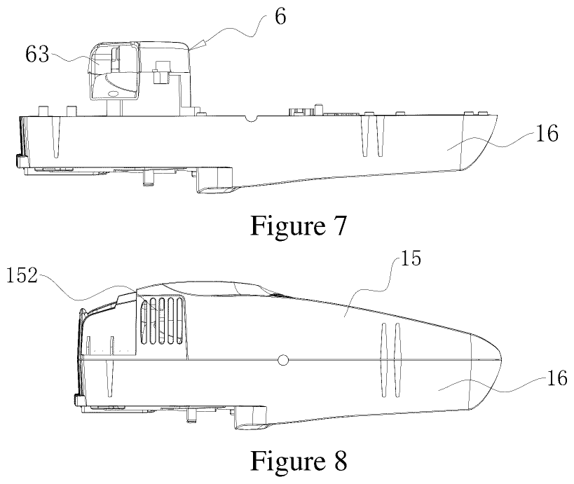

In this disclosure, please refer to FIG. 7 and FIG. 8. An area of the air guiding opening 63 is further the same as an area of the air outlet 152, so that when the air guiding opening 63 discharges the air, the air outlet 152 may directly discharge the air discharged by the air guiding opening 63 to the outside. A phenomenon of turbulence does not appear at the air outlet 152, air outlet efficiency is further improved, and the heat dissipation effect is also increased.

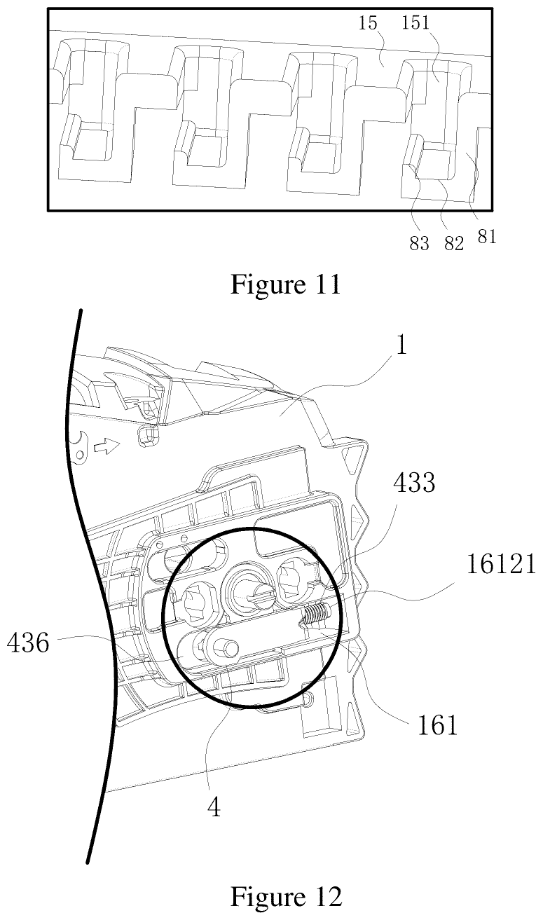

Please refer to FIG. 10 and FIG. 11. In an embodiment, the protective part 8 is located at a position of the air inlet 151, and the protective part 8 is connected with the housing 1. Through the protective part 8, the impurity and the small amount of liquid may be avoided from entering the housing 1 through the air inlet 151. The protective part 8 may be allowed to include a protective plate 82 and a connecting plate 81. One end of the connecting plate 81 arranged opposite to the heat dissipation passage and away from the protective plate 82 is fixedly connected with a top of the housing 1. Wherein, the protective plate 82 is fixedly connected with the connecting plate 81. An angle between the protective plate 82 and the connecting plate 81 is allowable to be between 60° and 90°, and the angle between the protective plate 82 and the connecting plate 81 is directed to the outside of the air inlet 151. In an embodiment, the angle between the protective plate 82 and the connecting plate 81 is 90°, and a projection of the air inlet 151 on the protective plate 82 is completely located within the protective plate 82. When the angle between the protective plate 82 and the connecting plate 81 is between 60° and 90°, water stain on the protective plate 82 may be avoided from flowing into the housing 1 autonomously. At the same time, since a projection of a boundary position of the air inlet 151 on the protective plate 82 is completely located within the protective plate 82, impurities such as the water stains may be effectively guaranteed to fall on the protective plate 82 as much as possible when the impurities enter the housing 1 through the air inlet 151. Therefore, when the airflow passes through the air inlet 151, the protective plate 82 may be used to change a direction of the airflow so as to avoid the airflow directly entering the housing 1 of the chainsaw. Since the air inlet 151 is an open structure, water and dust may enter the housing 1 through the air inlet 151 in a daily use of the chainsaw, which has an impact on the chainsaw. However, through arranging the protective part 8 on the air inlet 151, the protective part 8 may block the dust and water appropriately, so as to avoid the airflow directly entering the chainsaw.

Please refer to FIG. 11. In an embodiment, an edge of the protective part 8 on the heat dissipation passage is provided with a strip-shaped protruding rib 83. The protruding rib 83 is connected with the protective plate 82, and the protruding rib 83 is located at the edge position of the protective plate 82. It should be noted that, the protruding rib 83 is arranged along the edge of the protective plate 82 and is higher than the protective plate 82, so the protruding rib 83 may block the water stain on the protective plate 82, so as to improve a protective effect of the protective plate 82.

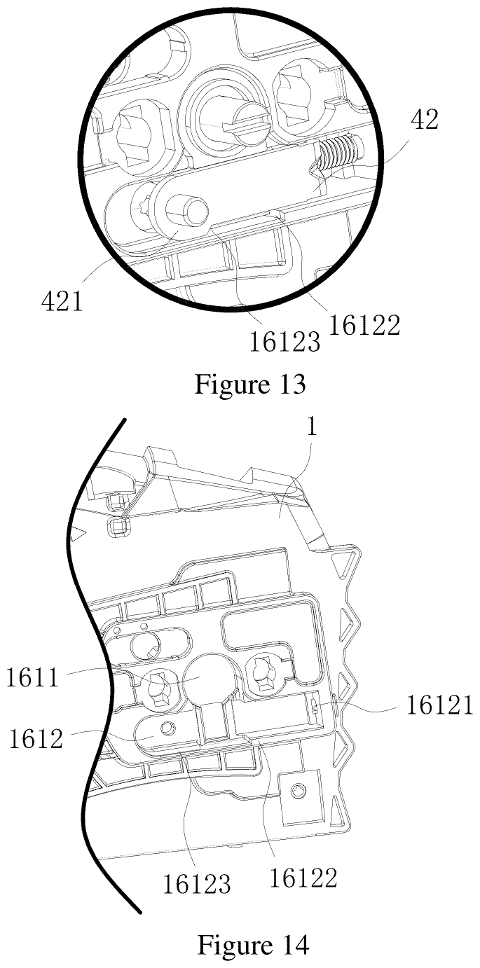

Please refer to FIG. 12 through FIG. 14. In this embodiment, a mounting groove 161 is arranged on the second casing 16 in the housing 1 close to the cutter 2. The mounting groove 161 is arranged along the length direction of the housing 1. The tensioning assembly 4 is placed in the mounting groove 161, and a first end of the tensioning assembly 4 is fixedly connected with a bottom wall of the mounting groove 161 through a pin 436. In addition, it should be noted that, an embedded hole 16121 is opened in a side wall of the mounting groove 161 close to the cutter 2. A second end of the tensioning assembly 4 extends into the embedded hole 16121, so that the two ends of the tensioning assembly 4 are fixed, and the tensioning assembly 4 is supported by the housing 1.

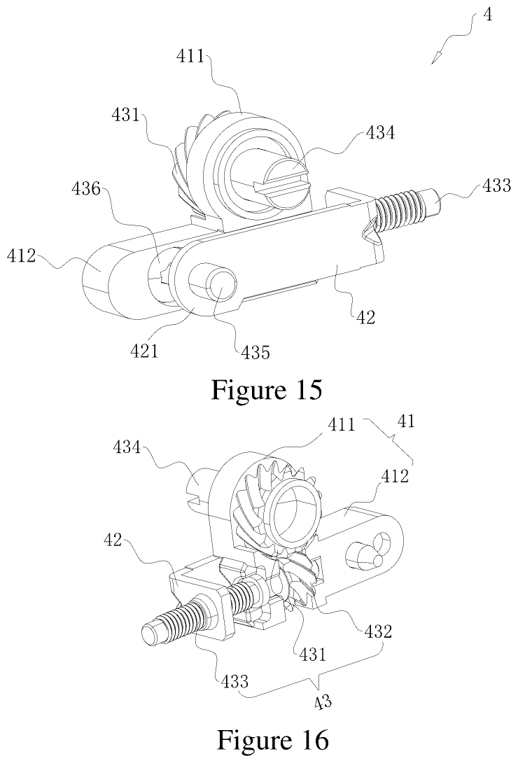

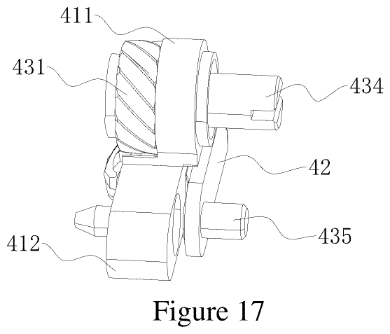

Please refer to FIG. 15 through FIG. 17. The tensioning assembly 4 includes a fixing part 41, an adjusting part 42 and a transmitting component 43.

One end of the fixing part 41 away from the cutter 2 is fixed with the bottom wall of the mounting groove 161 through the pin 436, and a plurality of grooves for mounting gears in the transmission component 43 and a plurality of through holes for shafts of the gears to pass through are arranged on the fixing part 41. The fixing part 41 is fixed with the bottom wall of the mounting groove 161 through the pin 436. Through a matching and fixing of the mounting groove 161 and the pin 436, a connection stability of the tensioning assembly 4 on the housing 1 may be increased. In addition, one end of a transmission rod 433 away from a second fixing part 412 abuts against the side wall of the mounting groove 161, so that the transmission rod 433 also plays a certain supporting role to the fixing part 41.

The adjusting part 42 is slidably connected with the fixing part 41 through the transmitting component 43, and the adjusting part 42 is L-shaped. A second connecting shaft 435 is fixed on a side plate with a longer length in the adjusting part 42, and the second connecting shaft 435 is fixedly connected with the guiding bar 22. The second connecting shaft 435 passes through a through hole on the guiding bar 22 to realize a connection between the adjusting part 42 and the guiding bar 22, so that the guiding bar 22 may reciprocate with the adjusting part 42.

One end of the transmitting component 43 extends into the embedded hole 16121 to realize a quick mounting of the tensioning assembly 4 and the housing 1.

In this embodiment, the transmitting component 43 includes a driving helical gear 431, a driven helical gear 432 and the transmission rod 433. Wherein, the driven helical gear 432 is rotatably connected in the groove of the fixing part 41, and an axis of the driven helical gear 432 is in a same direction as a length direction of the fixing part 41. The transmission rod 433 is arranged along the length direction of the fixing part 41. A first end of the transmission rod 433 is coaxially fixed with the driven helical gear 432. A middle section of the transmission rod 433 is rotatably connected with the fixing part 41 through a bearing, and an external thread is formed on a surface of a section of the transmission rod 433 close to the cutter 2, and is in a threaded connection with the adjusting part 42 through external threads. A second end of the transmission rod 433 extends into the embedded hole 16121. In addition, it should be noted that, one end of the transmission rod 433 extending into the embedded hole 16121 is unthreaded and in a smooth rod structure, so that it may rotate in the embedded hole 16121.

Further, in an embodiment of the disclosure, the fixing part 41 includes a first fixing part 411 and the second fixing part 412. The first fixing part 411 is a mounting block, and one end of the first fixing part 411 away from the cutter 2 is fixed with the bottom wall of the mounting groove 161 through the pin 436. The second fixing part 412 adopts a rounded lug plate. In some embodiments, the first fixing part 411 and the second fixing part 412 are integrally formed.

Corresponding to the first fixing part 411 and the second fixing part 412, the mounting groove 161 includes a first mounting groove 161land a second mounting groove 1612. The first fixing part 411 and the driving helical gear 431 are arranged in the first mounting groove 1611, and the second fixing part 412, the adjusting part 42, the driven helical gear 432 and the transmission rod 433 are arranged in the second mounting groove 1612. The second fixing part 412 is fixedly connected with a bottom wall of the second mounting groove 1612 through the pin 436, and the embedded hole 16121 is opened in a side wall of the second mounting groove 1612 close to the saw chain 21.

Further, in order to effectively control a moving trajectory of the adjusting part 42 along the transmission rod 433, a first blocking wall 16122 and a second blocking wall 16123 in a stepped shape are arranged on an inner side wall of the second mounting groove 1612, and the first blocking wall 16122 and the second blocking wall 16123 are perpendicular to each other. Correspondingly, a side wall of the adjusting part 42 extends toward an inner side wall of the second mounting groove 1612, thereby forming the blocking edge 421. The blocking edge 421 abuts against the first blocking wall 16122 of the inner side wall of the second mounting groove 1612, thereby limiting a movement range of the adjusting part 42 in a length direction of the transmission rod 433. The blocking edge 421 abuts against the second blocking wall 16123 of the inner side wall of the second mounting groove 1612, thereby limiting a movement range of the adjusting part 42 in a width direction of the transmission rod 433.

In this embodiment, in a process of mounting the tensioning assembly 4, the transmission rod 433 of the tensioning assembly 4 may extend into the embedded hole 16121, and the fixing part 41 in the tensioning assembly 4 is fixed through the pin 436, so that a stable mounting of the tensioning assembly 4 is realized. The driving helical gear 432 is rotatably connected with the first fixing part 411, located on an upper side of the driven helical gear 432 and meshed with the driven helical gear 432. And a first connecting shaft 434 is coaxially fixed on the driving helical gear 431. The first connecting shaft 434 passes through the side wall of the adjusting part 42 and extends to the outside of the housing 1, and a knob (not marked in the figure) is fixed at one end of the first connecting shaft 434 away from the driving helical gear 431.

In actual work, the user may rotate the knob and enable the driving helical gear 431 to rotate through a rotation of the first connecting shaft 434, thereby driving the driven helical gear 432 to rotate, and then driving a rotation of the transmission rod 433. The rotation of the transmission rod 433 drives the adjusting part 42 to move along a length direction of the second mounting groove 1612. And since the first blocking wall 16122 and the second blocking wall 16123 of the second mounting groove 1612 abut against the blocking edge 421 of the adjusting part 42 in the length direction and width direction, the adjusting part 42 is adjusted and moved according to a trajectory of the length direction of the second mounting groove 1612, and an adjusting range of the adjusting part 42 is limited.

In summary, the disclosure arranges the air guiding cover in the housing and placing the motor and the blower in the air guiding cover, so that it has a certain guiding effect on the airflow generated by the blower, which prevents the hot airflow around the motor from flowing in the housing. Through closely connecting the air guiding opening with the air outlet, the hot airflow may be prevented from flowing to other positions in the housing during the exchange of hot and cold air in the blower chamber, which may cause reducing the heat dissipation effect. Through setting the area of the air guiding opening to be the same as the area of the air outlet, the air outlet may directly discharge the air discharged from the air guiding opening to the outside when the air guiding opening is discharging, and there will be no turbulence at the air outlet, which further improves the air outlet efficiency and increases the heat dissipation effect.

Further, the fixing part is fixed with the bottom wall of the mounting groove through the pin, so that the connection stability of the tensioning assembly on the housing may be increased. In addition, an end of the transmission rod away from the fixing part extends into the embedded hole of the mounting groove, so that a quick fixation of the tensioning assembly may be realized, and the connection stability between the tensioning assembly and the housing is improved. Further, the first blocking wall and the second blocking wall are arranged through the inner side wall of the mounting groove in the stepped shape, the blocking edge is formed on the side wall of the adjusting part, and the blocking edge abuts against the first blocking wall and the second blocking wall at a step of the inner side wall of the mounting groove, so that the limiting of the adjusting range of the adjusting part is realized.

At the same time, the disclosure may effectively improve a problem that impurities and a small amount of liquid enter the housing through the air inlet in a process of use of the chainsaw. The heat dissipation passages are formed between the air inlet, the cavity, the air guiding opening, and the air outlet, and at the same time, the protective part is arranged at the bottom of the air inlet. The protruding ribs are arranged at the edge of the protective plate, which can effectively block moisture and dust while ensuring the heat dissipation, and prevents the dust and moisture carried in the airflow from directly entering an inside of the housing from the air inlet and damaging the motor. Therefore, the disclosure effectively overcomes various shortcomings in the prior art, thereby having high industrial utilization value.

The above embodiments only illustrate principles and effects of the disclosure, but are not intended to limit the disclosure. Anyone familiar with this technology may modify or change the above embodiments without departing from a scope of the disclosure. Therefore, all equivalent modifications or changes made by those with ordinary knowledge in the technical field without departing from the technical ideas disclosed in the disclosure shall still be covered by the claims of the disclosure.

In the description herein, a number of specific details, such as embodiments of components and/or methods, are provided to provide a complete understanding of the embodiments of the disclosure. However, those skilled in the art will recognize that embodiments of the disclosure may be practiced without one or more specific details or by other equipment, systems, assemblies, methods, components, materials, parts, etc. In other cases, the structure, material, or operation of that are commonly understood is not specified or described in detail so as to avoid obscuring aspects of the embodiments of the disclosure.

In the description of this specification, a description with reference to the terms “this embodiment”, “embodiment”, “specific embodiment”, etc. means that a specific feature, structure, or characteristic described in connection with this embodiment or example is included in at least one embodiment, and not necessarily in all embodiments. In this specification, schematic representations of the above terms in “this embodiment”, “embodiment”, “specific embodiment” do not necessarily refer to the same embodiment or example. Furthermore, the particular features, structures, materials or characteristics described may be combined in any suitable manner in any one or more embodiments or examples. It should be understood that other variants and modifications of the embodiments of the disclosure described and shown herein may be taught herein and will be deemed to be part of scope of the disclosure.

It should also be understood that one or more of the components shown in the drawings may also be implemented in a more separate or integrated manner, or may even be removed because it cannot be operated in some cases or may be provided because it is useful according to a particular application.

In addition, unless expressly indicated otherwise, any marking arrows in the drawings should be regarded only as exemplary instead of limiting. What's more, unless specified otherwise, the term “or” as used herein generally means “and/or.” In cases where the term is foreseen because it is unclear to provide separation or combination capabilities, the combination of components or operations will also be regarded as specified.

As used in the description herein and throughout the claims below, unless otherwise indicated, “a” and “the” include plural references. Similarly, as used in the description herein and throughout the claims below, unless otherwise indicated, “in the . . . ” includes “in the . . . ” and “on the . . . ”.

The above description of the illustrated embodiment of the disclosure (including content described in the abstract of the specification) is not intended to exhaustively enumerate or limit the disclosure to the precise form provided herein. Although specific embodiments of the disclosure and examples of the disclosure are described herein for illustrative purposes only, as those skilled in the art recognize and understand, various equivalent modifications are possible within the scope of the disclosure. As pointed out, these modifications may be made to the disclosure according to the above description of the embodiments of the disclosure, and these modifications will be within the scope of the disclosure.

This specification has generally described the system and method which are helpful in understanding the details of the disclosure. In addition, various specific details have been given to provide an overall understanding of the embodiments of the disclosure. However, those skilled in the relevant art will recognize that the embodiments of the disclosure may be realized without one or more specific details, or may be implemented through using other devices, systems, accessories, methods, assemblies, materials, parts, etc. In other cases, well-known structures, materials, and/or operations are not specifically shown or described in detail to avoid confusion in various aspects of the embodiments of the disclosure.

Therefore, although the disclosure has been described herein with reference to its specific embodiments, a freedom of modification, various changes and substitutions are also included in the above disclosure. And it should be understood that in some cases, without departing from the scope of the disclosure, some features of the disclosure will be adopted under the conditions without corresponding use of other features. Therefore, many modifications may be made to enable a specific environment or material to adapt the essential scope of the disclosure. The disclosure is not intended to limit the specific terms used in the claims and/or specific embodiments disclosed as the best embodiment for carrying out the disclosure, but the disclosure will include any and all embodiments and equivalents falling within the scope of the appended claims. Therefore, the scope of the disclosure will only be determined by the appended claims.

What is claimed is:

1. A chainsaw, comprising:
a housing, provided with at least one air inlet and one air outlet;
a cutter, mounted on the housing and comprising a saw chain and a guiding bar configured to support the saw chain;
a motor, arranged in the housing and configured to drive the cutter to work;
a tensioning assembly, mounted on the housing, connected with the guiding bar and configured to adjust a tightness of the saw chain; and
an air guiding cover, arranged in the housing, and the motor being arranged in the air guiding cover,
wherein, the housing is provided with a mounting groove configured to mount the tensioning assembly, heat dissipation passages are arranged between the air inlet, the air guiding cover and the air outlet to dissipate hot airflow generated by the motor to an outside.

2. The chainsaw according to claim 1, wherein, an embedded hole is arranged in a side wall of the mounting groove, a first end of the tensioning assembly is fixedly connected with a bottom wall of the mounting groove, and a second end of the tensioning assembly stretches into the embedded hole and is rotatable in the embedded hole.

3. The chainsaw according to claim 1, wherein, a protective part is arranged at a bottom of the air inlet, and the protective part is provided with a strip-shaped protruding rib located at an edge of the heat dissipation passage.

4. The chainsaw according to claim 3, wherein, the protective part comprises a protective plate and a connecting plate, and the protective plate and the connecting plate are arranged at an angle.

5. The chainsaw according to claim 4, wherein, the connecting plate is arranged opposite to the heat dissipation passage, one end of the connecting plate away from the protective plate is fixedly connected with a top of the housing, an edge of the protective plate away from the connecting plate is provided with the protruding rib, and the protruding rib is arranged along an edge of the protective plate and is higher than the protective plate.

6. The chainsaw according to claim 1, wherein, an air guiding opening is arranged on the air guiding cover, and the air guiding opening is arranged corresponding to a position and a size of the air outlet.

7. The chainsaw according to claim 6, wherein, an area of the air guiding opening is equal to an area of the air outlet.

8. The chainsaw according to claim 2, wherein, the tensioning assembly comprises a fixing part, an adjusting part and a transmitting component, the fixing part is fixedly connected with the bottom wall of the mounting groove through a pin, a plurality of grooves and a plurality of through holes matched with the transmitting component are opened on the fixing part, the adjusting part is slidably connected with the fixing part through the transmitting component, the transmitting component is in a transmission connection with the adjusting part, and one end of the transmitting component extends into the embedded hole.

9. The chainsaw according to claim 8, wherein, the fixing part comprises a first fixing part and a second fixing part that is vertically fixedly connected with the first fixing part, the transmitting component comprises a driving helical gear rotatably connected with the first fixing part, a driven helical gear rotatably connected with the second fixing part, located below the driving helical gear, and meshed with the driving helical gear, and a transmission rod, a first end of the transmission rod is coaxially fixed with the driven helical gear, and is in a transmission connection with the adjusting part, and a second end of the transmission rod extends into the embedded hole.

10. The chainsaw according to claim 9, wherein, the mounting groove comprises a first mounting groove and a second mounting groove, the first fixing part and the driving helical gear are arranged in the first mounting groove, the second fixing part, the adjusting part, the driven helical gear and the transmission rod are arranged in the second mounting groove, the second fixing part is fixedly connected with a bottom wall of the second mounting groove through a pin, and the embedded hole is opened in a side wall of the second mounting groove close to the saw chain.

11. The chainsaw according to claim 6, wherein, the air guiding cover comprises a first cover and a second cover, the second cover is connected with the first cover, a cavity is arranged between the first cover and the second cover, an air guiding tube is further connected with one side of the first cover away from the second cover, the air guiding tube is connected with the motor, a bottom of the second cover is provided with the air guiding opening, and the air guiding opening is communicated with the cavity.

12. The chainsaw according to claim 11, wherein, the air guiding opening is arranged opposite to the air outlet, and the heat dissipation passages are formed between the air inlet, the cavity, the air guiding opening and the air outlet.

13. The chainsaw according to claim 11, wherein, a blower chamber is further formed between the first cover and the second cover, and a blower is arranged in the blower chamber.

14. The chainsaw according to claim 1, wherein, the housing comprises a first casing, a second casing and an upper cover, the second casing is connected with the first casing and forms an empty cavity with the first casing, the motor is arranged in the empty cavity, and the upper cover is fixed on tops of the first casing and the second casing.

15. The chainsaw according to claim 14, wherein, a plurality of the air outlets is arranged at a bottom of the first casing and arranged linearly.
